(19) United States
(12) Patent Application Publication
(10) Pub. No.: US 2022/0318697 A1
(43) Pub. Date: Oct. 6, 2022

(54) INTELLIGENT MANAGEMENT SYSTEM, INTELLIGENT MANAGEMENT METHOD, AND COMPUTER-PROGRAM PRODUCT

(71) Applicant: BOE Technology Group Co., Ltd., Beijing (CN)

(72) Inventors: Nan Liu, Beijing (CN); Chuan Wang, Beijing (CN); Xuemei Lin, Beijing (CN); Jianmin Wu, Beijing (CN); Hong Wang, Beijing (CN)

(73) Assignee: BOE Technology Group Co., Ltd., Beijing (CN)

(21) Appl. No.: 17/311,348

(22) PCT Filed: Sep. 3, 2020
(86) PCT No.: PCT/CN2020/113223

§ 371 Date: Jun. 7, 2021

(51) Int. Cl. G06Q 10/06; G06Q 10/08; G06Q 30/02

(52) U.S. Cl. CPC G06Q 10/0633; G06Q 10/087; G06Q 30/0202

(57) ABSTRACT

An intelligent management system is provided. The intelligent management system includes an intelligent supply chain manager configured to generate supply chain limitations based on a supply chain knowledge graph comprising information of at least one of demand planning and forecasting, inventory planning, sales planning and forecasting, or budget planning; generate industry chain contingencies based on an industry chain event knowledge graph comprising information of at least one of event urgency level, event importance level, and event impact spread level; generate constraints on supply chain based on supply chain limitations and industry chain contingencies; and generate a proposal and provide the proposal to business systems for supply chain planning based on the constraints on supply chain, the proposal comprising proposal for at least one of demand re-planning and re-forecasting, inventory re-planning, sales re-planning and re-forecasting, or budget re-planning.

### TECHNICAL FIELD

The present invention relates to intelligent management technology, more particularly, to an intelligent management system, an intelligent management method, and a computer-program product.

### BACKGROUND

A supply chain is a logistics network including suppliers, manufacturers, warehouses, distribution centers, and channel providers. The same business entity may function as different constituent nodes in the supply chain network. For example, in a given supply chain network, a same enterprise may be the manufacturer, and have warehouse center and distribution center. More often, however, different business entities form different nodes in the network.

### SUMMARY

In one aspect, the present disclosure provides an intelligent management system, comprising a supply chain knowledge graph; an industry chain event knowledge graph; and an intelligent supply chain manager connected to the supply chain knowledge graph and the industry chain event knowledge graph; wherein the intelligent supply chain manager comprises a memory; one or more processors; wherein the memory and the one or more processors are connected with each other; and the memory stores computer-executable instructions for controlling the one or more processors to generate supply chain limitations based on the supply chain knowledge graph comprising information of at least one of demand planning and forecasting, inventory planning, sales planning and forecasting, or budget planning; generate industry chain contingencies based on the industry chain event knowledge graph comprising information of at least one of event urgency level, event importance level, and event impact spread level; generate constraints on supply chain based on supply chain limitations and industry chain contingencies; and generate a proposal and provide the proposal to business systems for supply chain planning based on the constraints on supply chain, the proposal comprising proposal for at least one of demand re-planning and re-forecasting, inventory re-planning, sales re-planning and re-forecasting, or budget re-planning.

Optionally, the memory further stores computer-executable instructions for controlling the one or more processors to generate an alarm and provide the alarm to the business systems based on a potential conflict between the supply chain limitations and industry chain contingencies; and receive a confirmation from the business systems confirming the potential conflict; wherein the proposal is generated upon receiving the confirmation.

Optionally, the proposal comprises a set of alternative proposals respectively based on alternative priorities.

Optionally, the intelligent management system further comprises a supply chain knowledge graph generator configured to generate the supply chain knowledge graph by extracting entities, relationships, and attributes from sources comprising at least one of the business systems or industry standards; wherein the supply chain knowledge graph generator comprises a memory; one or more processors; wherein the memory and the one or more processors are connected with each other; and the memory stores computer-executable instructions for controlling the one or more processors to extract entities and relationships from structured data using an extraction tool; extract entities, relationships, and attributes from unstructured data respectively using entity extraction template, relationship extraction template, and attribute extraction template; and store extracted entities, extracted relationships, and extracted attributes in knowledge graph database, upon expert validation.

Optionally, to extract entities, relationships, and attributes from the unstructured data, the memory further stores computer-executable instructions for controlling the one or more processors to construct entity recognition dictionary and entity recognition rules; expand the entity recognition rules using heuristic algorithm to generate new rules, based on the entity recognition dictionary and the entity recognition rules; construct entity recognition rule base comprising the entity recognition rules and the new rules; construct the entity extraction template based on the entity recognition rule base; and construct the relationship extraction template and attribute extraction template based on keywords, lexical, and syntactic analysis.

Optionally, the intelligent management system further comprises an industry chain event knowledge graph generator configured to generate the industry chain event knowledge graph by extracting entities, relationships, and attributes from sources comprising at least one of and internal knowledge base or public web knowledge base; wherein the industry chain event knowledge graph generator comprises a memory; one or more processors; wherein the memory and the one or more processors are connected with each other; and the memory stores computer-executable instructions for controlling the one or more processors to crawl the public web knowledge base by a web crawler to obtain trending events in a relevant industry; extract entities, relationships, and attributes from the trending events respectively using entity extraction template, relationship extraction template, and attribute extraction template; perform knowledge fusion among the internal knowledge base, extracted entities, extracted relationships, and extracted attributes to generate a fused knowledge base; extract new keywords from a fused knowledge base; and reiterate crawling the public web knowledge base, extracting entities, relationships, and attributes from the trending events, and performing knowledge fusion.

Optionally, to extract entities, relationships, and attributes from the trending events, the memory further stores computer-executable instructions for controlling the one or more processors to construct entity recognition dictionary and entity recognition rules; expand the entity recognition rules using heuristic algorithm to generate new rules, based on the entity recognition dictionary and the entity recognition rules; construct entity recognition rule base comprising the entity recognition rules and the new rules; construct the entity extraction template based on the entity recognition rule base; and construct the relationship extraction template and attribute extraction template based on keywords, lexical, and syntactic analysis.

Optionally, the memory further stores computer-executable instructions for controlling the one or more processors to reiterate crawling the public web knowledge base, extracting entities, relationships, and attributes from the trending events, and performing knowledge fusion.

Optionally, the memory further stores computer-executable instructions for controlling the one or more processors to generate trending events summary based on a TextRank algorithm; wherein, to generate the trending events summary, the memory stores computer-executable instructions for controlling the one or more processors to treat sentences in the industry chain event knowledge graph as nodes; connect nodes in the industry chain event knowledge graph with vectorless weighted edges, wherein a respective weight of a respective edge is a similarity between respective two nodes connected by the respective edge; construct a vectorless weighted graph G (V, E, W) based on the nodes and the vectorless weighted edges, wherein V stands for the nodes, E stands for the vectorless weighted edges, and W stands for similarities respectively between connected nodes; calculate importance respectively of the nodes; rank the importance respectively of the nodes; and form the trending events summary using selected nodes having relatively high ranking.

Optionally, the importance are calculated according to Equation (1):

$$WS ( {S}_{i} ) = ( 1 - d ) + d * {\sum }_{{S}_{j} ∈ In ( {S}_{i} )} WS ( {S}_{j} ) * \frac{{w}_{ji}}{{\sum }_{{S}_{k} ∈ Out ( {S}_{j} )} {w}_{jk}} ; \qquad ( 1 )$$

wherein Sᵢ stands for an i-th node; WS(Sᵢ) stands for importance for the i-th node; Sⱼ stands for an j-th node: wⱼᵢ stands for similarity between the i-th node and the j-th node; d stands for a damping coefficient, indicating probability of the i-th node being selected as one of the selected nodes; ln(Sᵢ) stands for a set of nodes pointing to the i-th node; Out(Sⱼ) stands for a set of nodes pointing to the j-th node.

Optionally, to crawl the public web knowledge base by the web crawler, the memory further stores computer-executable instructions for controlling the one or more processors to initialize a crawler task based on a seed webpage; download and parse the seed webpage to locate basic information on the seed webpage according to JSoup selector syntax; add related events, tasks, and links to entity words on the seed webpage to a crawl queue; and store parsed data in Json format to a text.

Optionally, the entity extraction template is configured to extract one or more entities selected from a group consisting of factory, logistics company, order, raw material supplier, part supplier, subcontractor, distributor, inventory, material, budget, country, region, industry chain long downstream enterprise, partner, outsourcing vendor, key equipment, financial institution, market, policy, production plan, industry standard, output, order priority level, target, single line production index, product cycle, constraint, production stoppage, abnormal weather, disease, natural disaster, personnel transfer, and time.

Optionally, the relationship extraction template is configured to extract one or more relationships selected from a group consisting of acquisition, financing, merger, upstream, downstream, receipt, payment, pickup, delivery, demand, purchase, maintenance, from, containment, cooperation, strategic partnership, impact, conformity, distribution, priority, receipt, bottleneck, limitation, cause and effect, chronology, and regional relationships.

Optionally, the attribute extraction template is configured to extract one or more attributes selected from a group consisting of position, amount, order status, delivery status, enterprise status, equipment status, cooperation status, transportation status, production status, financial status, payment status.

Optionally, the intelligent management system further comprises a supply chain knowledge graph generator configured to generate the supply chain knowledge graph and an industry chain event knowledge graph generator configured to generate the industry chain event knowledge graph; wherein at least one of the supply chain knowledge graph generator or the industry chain event knowledge graph generator comprises an inferencer configured to infer at least one of a relationship between two entities or a category for an entity.

Optionally, the inferencer comprises a memory; one or more processors; wherein the memory and the one or more processors are connected with each other; and the memory stores computer-executable instructions for controlling the one or more processors to infer the category for the entity based on constraints in ontological framework of a knowledge graph, the constraints comprising definition domain and value domain of a relationship connected to the entity.

Optionally, the inferencer comprises a memory; one or more processors; wherein the memory and the one or more processors are connected with each other; and the memory stores computer-executable instructions for controlling the one or more processors to make an inference using a scoring algorithm; wherein the scoring algorithm comprises similarity between entity 1 and (relationship Ô entity 2); similarity between (entity 1 Ô relationship) and entity 2; and similarity between relationship and (entity 1 Ô entity 2); wherein Ô stands for a linear or non-linear operation selected from a group consisting of addition, multiplication, and a neural network operation.

Optionally, the memory further stores computer-executable instructions for controlling the one or more processors to train parameters of the scoring algorithm using a training data set.

In another aspect, the present disclosure provides an intelligent management method, comprising generating supply chain limitations based on a supply chain knowledge graph comprising information of at least one of demand planning and forecasting, inventory planning, sales planning and forecasting, or budget planning; generating industry chain contingencies based on an industry chain event knowledge graph comprising information of at least one of event urgency level, event importance level, and event impact spread level; generating constraints on supply chain based on supply chain limitations and industry chain contingencies; and generating a proposal and providing the proposal to business systems for supply chain planning based on the constraints on supply chain, the proposal comprising proposal for at least one of demand re-planning and re-forecasting, inventory re-planning, sales re-planning and re-forecasting, or budget re-planning.

In another aspect, the present disclosure provides a computer-program product, comprising a non-transitory tangible computer-readable medium having computer-readable instructions thereon, the computer-readable instructions being executable by a processor to cause the processor to perform generating supply chain limitations based on a supply chain knowledge graph comprising information of at least one of demand planning and forecasting, inventory planning, sales planning and forecasting, or budget planning; generating industry chain contingencies based on an industry chain event knowledge graph comprising information of at least one of event urgency level, event importance level, and event impact spread level; generating constraints on supply chain based on supply chain limitations and industry chain contingencies; and generating a proposal and providing the proposal to business systems for supply chain planning based on the constraints on supply chain, the proposal comprising proposal for at least one of demand re-planning and re-forecasting, inventory re-planning, sales re-planning and re-forecasting, or budget re-planning.

### BRIEF DESCRIPTION OF THE FIGURES

The following drawings are merely examples for illustrative purposes according to various disclosed embodiments and are not intended to limit the scope of the present invention.

FIG. 1 illustrates an intelligent management system in some embodiments according to the present disclosure.

FIG. 2A is a schematic diagram of a structure of an apparatus in some embodiments according to the present disclosure.

FIG. 2B is a schematic diagram illustrating the structure of an apparatus in some embodiments according to the present disclosure.

FIG. 3 illustrates functional modules of a supply chain knowledge graph in some embodiments according to the present disclosure.

FIG. 4 illustrates functional modules of an industry chain event knowledge graph in some embodiments according to the present disclosure.

FIG. 5 illustrates an intelligent management system in some embodiments according to the present disclosure.

FIG. 6 illustrates functional modules of a supply chain knowledge graph in some embodiments according to the present disclosure.

FIG. 7 illustrates an intelligent management system in some embodiments according to the present disclosure.

FIG. 8 illustrates a method of generating a supply chain knowledge graph in some embodiments according to the present disclosure.

FIG. 9 illustrates a method of generating an industry chain event knowledge graph in some embodiments according to the present disclosure.

FIG. 10 illustrates the structure of an industry chain event knowledge graph in some embodiments according to the present disclosure.

FIG. 11 illustrates an intelligent management system in some embodiments according to the present disclosure.

FIG. 12 illustrates the structure of an inferencer in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

The inventors of the present disclosure discover that a common supply chain management system lacks the ability to respond to uncertainties and volatilities fast, because it does not have the ability to timely predict shortage, analyze events, infer connections, or assist in decision-making. Also, database in the common supply chain management system cannot be easily maintained and expanded.

Accordingly, the present disclosure provides, inter alia, an intelligent management system, an intelligent management method, and a computer-program product that substantially obviate one or more of the problems due to limitations and disadvantages of the related art. In one aspect, the present disclosure provides an intelligent management system. In some embodiments, the intelligent management system includes a supply chain knowledge graph; an industry chain event knowledge graph; an intelligent supply chain manager connected to the supply chain knowledge graph and the industry chain event knowledge graph. Optionally, the intelligent supply chain manager includes a memory; one or more processors. The memory and the one or more processors are connected with each other. The memory stores computer-executable instructions for controlling the one or more processors to generate supply chain limitations based on the supply chain knowledge graph comprising information of at least one of demand planning and forecasting, inventory planning, sales planning and forecasting, or budget planning; generate industry chain contingencies based on the industry chain event knowledge graph comprising information of at least one of event urgency level, event importance level, and event impact spread level; generate constraints on supply chain based on supply chain limitations and industry chain contingencies; and generate a proposal and provide the proposal to business systems for supply chain planning based on the constraints on supply chain, the proposal comprising proposal for at least one of demand re-planning and re-forecasting, inventory re-planning, sales re-planning and re-forecasting, or budget re-planning.

As used herein, the term “knowledge graph” may denote a networked data structure comprising facts, represented in nodes, and edges representing connections or links between the nodes. Thus, the knowledge graph may represent a knowledge base for an organization of so-called unstructured data, i.e., facts, and their semantic relationships. Core building blocks of a knowledge graph may be nodes comprising the information and edges building links between selected different nodes. The edges may have weights, or weight factors, defining a strength value of a relationship between two nodes. Additionally, the nodes may also have scores or score values, describing some sort of importance of the content of the nodes. As used herein, the term “entity” refers to a category of things or objects which are each recognized as being capable of an independent existence and which can be uniquely identified. An entity is typically represented by a node in the knowledge graph. As used herein, the term “relationship” refers to relationship between entities. A relationship is typically represented by an edge in the knowledge graph. As used herein, the term “attribute” refers to a characteristic that can be obtained about an entity.

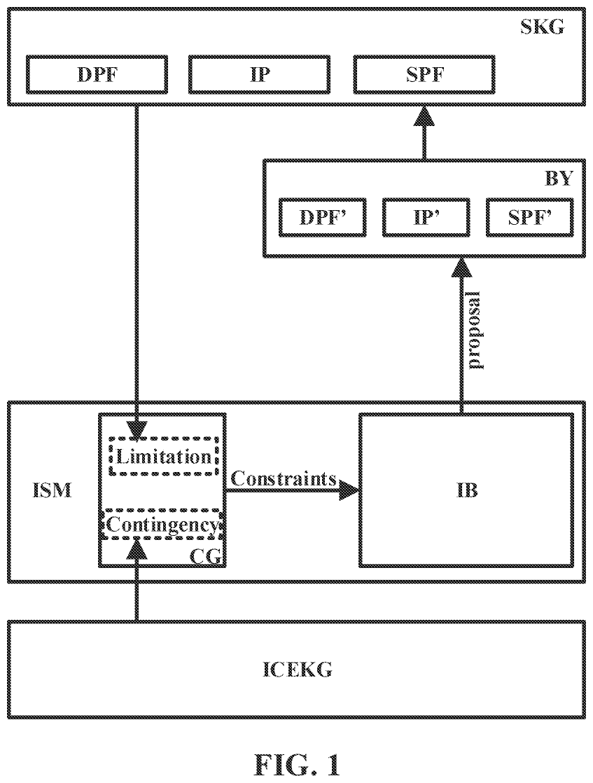

FIG. 1 illustrates an intelligent management system in some embodiments according to the present disclosure. Referring to FIG. 1, the intelligent management system in some embodiments includes a supply chain knowledge graph SKG; an industry chain event knowledge graph ICEKG; an intelligent supply chain manager ISM connected to the supply chain knowledge graph SKG and the industry chain event knowledge graph ICEKG.

In some embodiments, the intelligent supply chain manager ISM includes a constraint generator CG configured to generate constraints on supply chain. Specifically, the constraint generator CG is configured to generate supply chain limitations based on the supply chain knowledge graph comprising information of at least one of demand planning and forecasting, inventory planning, or sales planning and forecasting; generate industry chain contingencies based on the industry chain event knowledge graph comprising information of at least one of event urgency level, event importance level, and event impact spread level; and generate constraints on supply chain based on supply chain limitations and industry chain contingencies. In some embodiments, the intelligent supply chain manager ISM further includes an intelligent butler IB configured to receive the constraints generated by the constraint generator CG, and generate a proposal and provide the proposal to business systems BY for supply chain planning based on the constraints on supply chain, the proposal comprising proposal for at least one of demand re-planning and re-forecasting, inventory re-planning, or sales re-planning and re-forecasting.

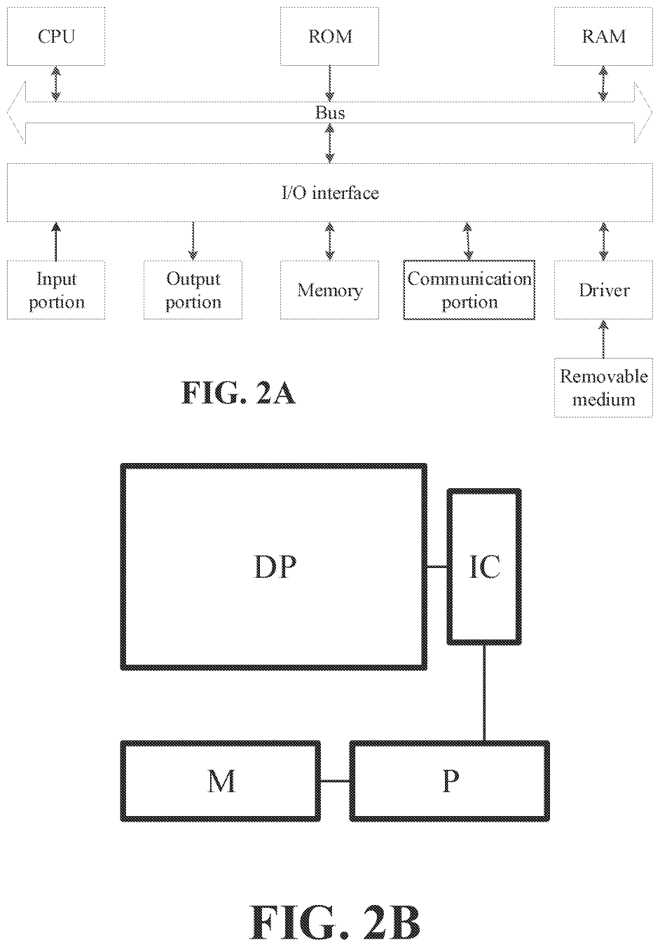

FIG. 2A is a schematic diagram of a structure of an intelligent supply chain manager ISM in some embodiments according to the present disclosure. Referring to FIG. 2A, in some embodiments, the apparatus includes the central processing unit (CPU) configured to perform actions according to the computer-executable instructions stored in a ROM or in a RAM. Optionally, data and programs required for a computer system are stored in RAM. Optionally, the CPU, the ROM, and the RAM are electrically connected to each other via bus. Optionally, an input/output interface is electrically connected to the bus.

FIG. 2B is a schematic diagram illustrating the structure of an intelligent supply chain manager ISM in some embodiments according to the present disclosure. Referring to FIG. 2B, in some embodiments, the apparatus includes a display panel DP; an integrated circuit IC connected to the display panel DP; a memory M; and one or more processors P. The memory M and the one or more processors P are connected with each other. In some embodiments, the memory M stores computer-executable instructions for controlling the one or more processors P to execute method steps described herein.

In some embodiments, the intelligent supply chain manager includes a memory; one or more processors. The memory and the one or more processors are connected with each other. In some embodiments, the memory stores computer-executable instructions for controlling the one or more processors to generate supply chain limitations based on the supply chain knowledge graph comprising information of at least one of demand planning and forecasting, inventory planning, or sales planning and forecasting; generate industry chain contingencies based on the industry chain event knowledge graph comprising information of at least one of event urgency level, event importance level, and event impact spread level; generate constraints on supply chain based on supply chain limitations and industry chain contingencies; and generate a proposal and provide the proposal to business systems BY for supply chain planning based on the constraints on supply chain, the proposal comprising proposal for at least one of demand re-planning and re-forecasting, inventory re-planning, or sales re-planning and re-forecasting.

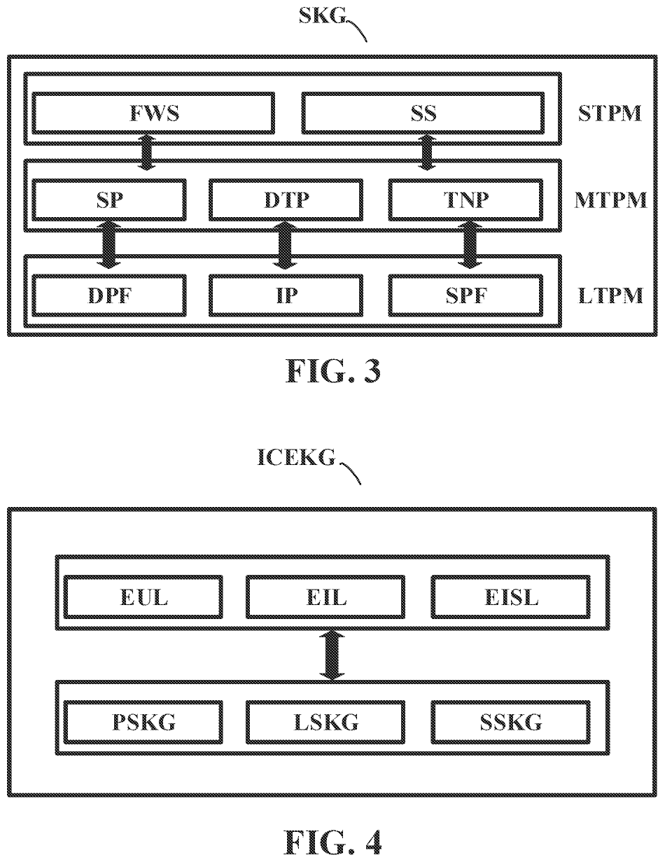

Referring to FIG. 1 again, the business systems BY in some embodiments includes demand planning and forecasting module DPF (e.g., planning on how to meet market demand and forecasting market needs), inventory planning module IP (e.g., planning on warehouse inventory), and sales planning and forecasting module SPF (e.g., planning on and forecasting sales). FIG. 3 illustrates functional modules of a supply chain knowledge graph in some embodiments according to the present disclosure. Referring to FIG. 3, the supply chain knowledge graph SKG in some embodiments includes short-term planning modules STPM, mid-term planning modules MTPM, and long-term planning modules LTPM. In one example, the short-term planning modules STPM include field work scheduling module FWS and shipment scheduling module SS; the mid-term planning modules MTPM include supply planning module SP, distribution planning module DTP, and transportation planning module TNP; and the long-term planning modules LTPM include demand planning and forecasting module DPF, inventory planning module IP, and sales planning and forecasting module SPF. The supply chain limitations are generated based on information of at least one of demand planning and forecasting, inventory planning, or sales planning and forecasting, which are respectively from the demand planning and forecasting module DPF, inventory planning module IP, and sales planning and forecasting module SPF. From information contained in the long-term planning modules LTPM, the constraint generator CG in FIG. 1 is configured to generate supply chain limitations.

FIG. 4 illustrates functional modules of an industry chain event knowledge graph in some embodiments according to the present disclosure. Referring to FIG. 4, the industry chain event knowledge graph ICEKG in some embodiments includes a plurality of sub-knowledge graphs, examples of which including a procurement sub-knowledge graph PSKG, a logistics sub-knowledge graph LSKG, and a sales sub-knowledge graph SSKG. From these sub-knowledge graphs, information of industry events may be extracted, including event urgency level EUL, event importance level EIL, and event impact spread level EISL. The constraint generator CG in FIG. 1 is configured to generate industry chain contingencies respectively corresponding to the event urgency level EUL, event importance level EIL, and event impact spread level EISL.

The intelligent butler IB is configured to analyze existing demand planning and forecasting, inventory planning, sales planning and forecasting, considering the supply chain limitations and industry chain contingencies, forecasting delays in supply, delays in demand, and delays in logistics, thereby proposing at least one of demand re-planning and re-forecasting, inventory re-planning, or sales re-planning and re-forecasting.

Referring to FIG. 1 again, the business systems BY in some embodiments includes demand planning and forecasting system DPF′, inventory planning system IP′, and sales planning and forecasting system SPF′. The proposals for the demand re-planning and re-forecasting, the inventory re-planning, and the sales re-planning and re-forecasting are respectively provided to the demand planning and forecasting system DPF′, the inventory planning system IP′, and the sales planning and forecasting system SPF′. Users in a production business entity, a procurement business entity, and a sales business entity can respectively review the proposals for the demand re-planning and re-forecasting, the inventory re-planning, and the sales re-planning and re-forecasting.

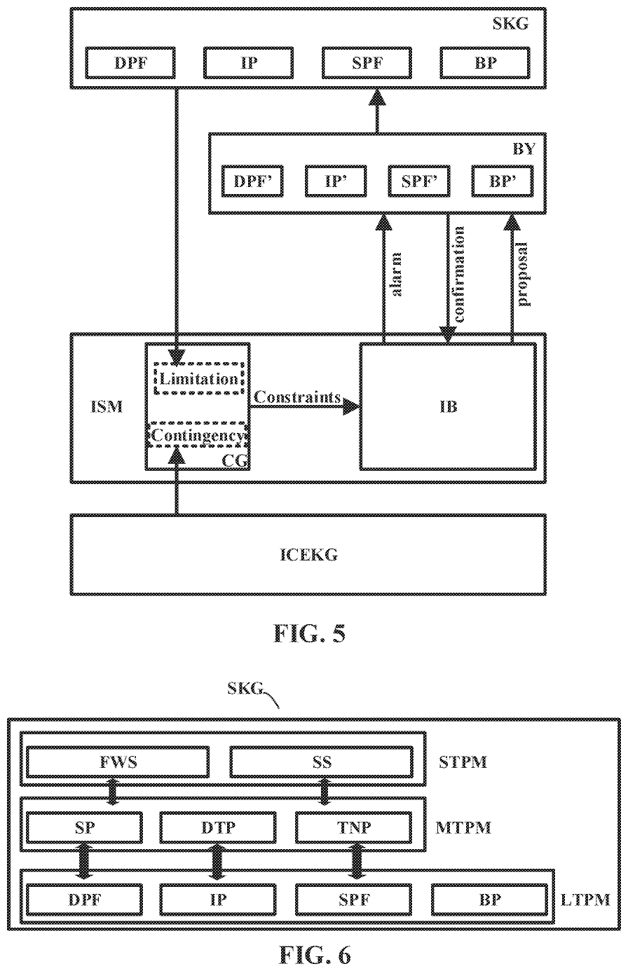

FIG. 5 illustrates an intelligent management system in some embodiments according to the present disclosure. FIG. 6 illustrates functional modules of a supply chain knowledge graph in some embodiments according to the present disclosure. Referring to FIG. 5 and FIG. 6, the supply chain knowledge graph SKG in some embodiments includes short-term planning modules STPM, mid-term planning modules MTPM, and long-term planning modules LTPM. In one example, the short-term planning modules STPM include field work scheduling module FWS and shipment scheduling module SS; the mid-term planning modules MTPM include supply planning module SP, distribution planning module DTP, and transportation planning module TNP; and the long-term planning modules LTPM include demand planning and forecasting module DPF, inventory planning module IP, sales planning and forecasting module SPF, and budget planning module BP. The supply chain limitations are generated based on information of at least one of demand planning and forecasting, inventory planning, sales planning and forecasting, or budget planning, which are respectively from the demand planning and forecasting module DPF, inventory planning module IP, sales planning and forecasting module SPF, and budget planning module BP.

From information contained in the long-term planning modules LTPM, the constraint generator CG in FIG. 5 is configured to generate supply chain limitations. The supply chain limitations are generated based on information of at least one of demand planning and forecasting, inventory planning, sales planning and forecasting, or budget planning, which are respectively from the demand planning and forecasting module DPF, inventory planning module IP, and sales planning and forecasting module SPF.

The intelligent butler IB is configured to receive the constraints generated by the constraint generator CG, and generate a proposal and provide the proposal to business systems BY for supply chain planning based on the constraints on supply chain, the proposal comprising proposal for at least one of demand re-planning and re-forecasting, inventory re-planning, sales re-planning and re-forecasting, or budget re-planning. Specifically, the intelligent butler IB is configured to analyze existing demand planning and forecasting, inventory planning, sales planning and forecasting, considering the supply chain limitations and industry chain contingencies, forecasting delays in supply, delays in demand, and delays in logistics, thereby proposing at least one of demand re-planning and re-forecasting, inventory re-planning, sales re-planning and re-forecasting, or budget re-planning.

In some embodiments, the intelligent supply chain manager includes a memory; one or more processors. The memory and the one or more processors are connected with each other. In some embodiments, the memory stores computer-executable instructions for controlling the one or more processors to generate supply chain limitations based on the supply chain knowledge graph comprising information of at least one of demand planning and forecasting, inventory planning, sales planning and forecasting, or budget planning; generate industry chain contingencies based on the industry chain event knowledge graph comprising information of at least one of event urgency level, event importance level, and event impact spread level; generate constraints on supply chain based on supply chain limitations and industry chain contingencies; and generate a proposal and provide the proposal to business systems BY for supply chain planning based on the constraints on supply chain, the proposal comprising proposal for at least one of demand re-planning and re-forecasting, inventory re-planning, sales re-planning and re-forecasting, or budget re-planning.

Referring to FIG. 5 again, the business systems BY in some embodiments includes demand planning and forecasting system DPF′, inventory planning system IP′, sales planning and forecasting system SPF′, and budget planning system BP′. The proposals for the demand re-planning and re-forecasting, the inventory re-planning, the sales re-planning and re-forecasting, and the budget re-planning are respectively provided to the demand planning and forecasting system DPF′, the inventory planning system IP′, the sales planning and forecasting system SPF′, and the budget planning system BP′. Users in a production business entity, a procurement business entity, a sales business entity, and a finance business entity (e.g., a production department, a procurement department, a sales department, and a finance department in a same enterprise) can respectively review the demand re-planning and re-forecasting, the inventory re-planning, the sales re-planning and re-forecasting, and the budget re-planning.

In some embodiments, the intelligent butler IB is configured to generate an alarm and provide the alarm to the business systems BY based on a potential conflict between the supply chain limitations and industry chain contingencies. Examples of alarms generated due to the potential conflict between the supply chain limitations and industry chain contingencies include a warning of potential material shortage, a warning of potential production capacity shortage, a warning of potential delays in the custom order delivery. The alarms in some embodiments also include a comparison between existing plans and predicted reality.

In some embodiments, the business systems BY (e.g., the demand planning and forecasting system DPF′, the inventory planning system IP′, the sales planning and forecasting system SPF′, and the budget planning system BP′) are configured to transmit a confirmation, confirming the potential conflict. In one example, a user on the business systems BY can review and confirm the potential conflict. The intelligent butler IB is configured to receive the confirmation from the business systems BY confirming the potential conflict. Upon receiving the confirmation, the intelligent butler IB is configured to generate the proposal and provide the proposal to business systems BY for supply chain planning based on the constraints on supply chain, the proposal including proposal for at least one of demand re-planning and re-forecasting, inventory re-planning, sales re-planning and re-forecasting, or budget re-planning.

Optionally, the proposal includes a set of alternative proposals respectively based on alternative priorities, for example, priority placed on delivery, priority placed on procurement, etc. Optionally, the potential conflict between the supply chain limitations and industry chain contingencies is resolved in each of the alternative proposals.

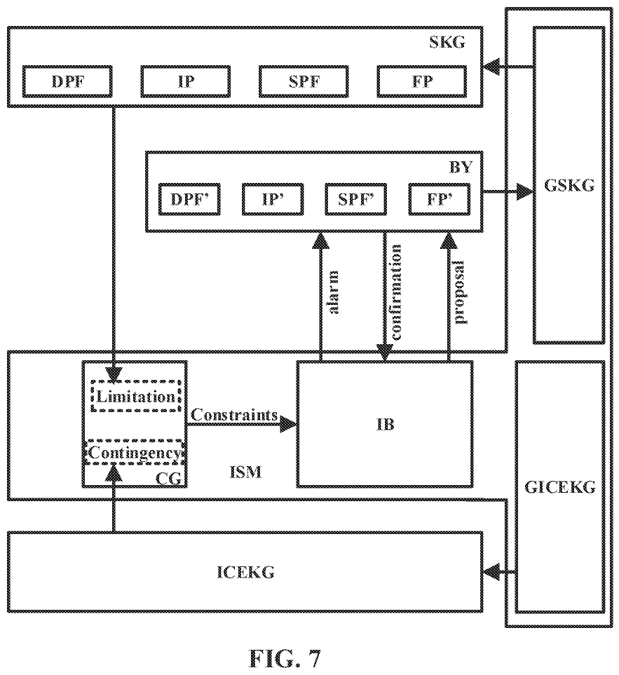

FIG. 7 illustrates an intelligent management system in some embodiments according to the present disclosure. Referring to FIG. 7, the intelligent management system ISM in some embodiments further includes a supply chain knowledge graph generator GSKG configured to generate the supply chain knowledge graph SKG by extracting entities, relationships, and attributes from sources comprising at least one of the business systems or industry standards. In some embodiments, the supply chain knowledge graph generator SKG includes a memory and one or more processors. The memory and the one or more processors are connected with each other. The memory stores computer-executable instructions for controlling the one or more processors to extract entities and relationships from structured data using an extraction tool; extract entities, relationships, and attributes from unstructured data respectively using entity extraction template, relationship extraction template, and attribute extraction template; and store extracted entities, extracted relationships, and extracted attributes in knowledge graph database, upon expert validation. Optionally, the extraction tool is an extraction-transform-loading (ETL) tool. Examples of sources from which the entities, relationships, and attributes can be extracted further include process files, documents, cases, device information.

As used herein, the term “structured data” refers to a data wherein the semantic meaning of the stored data is explicitly defined. For example, a structured data source includes relational databases, XML databases, and the like. The term “unstructured data” is used to refer to a data source wherein the semantic meaning of the data is not explicitly defined. For example, unstructured data can refer to plain text documents, scanned documents, ADOBE® Portable Document Files (PDFs), Microsoft® Word documents. The term “unstructured data” is also used herein to refer to semi-structured data, wherein the semantic meaning of the data is encoded, for example, using metadata tags. Examples of semi-structured documents include eXtensible Markup Language (XML) files, and HyperText Markup Language (HTML) files, among others.

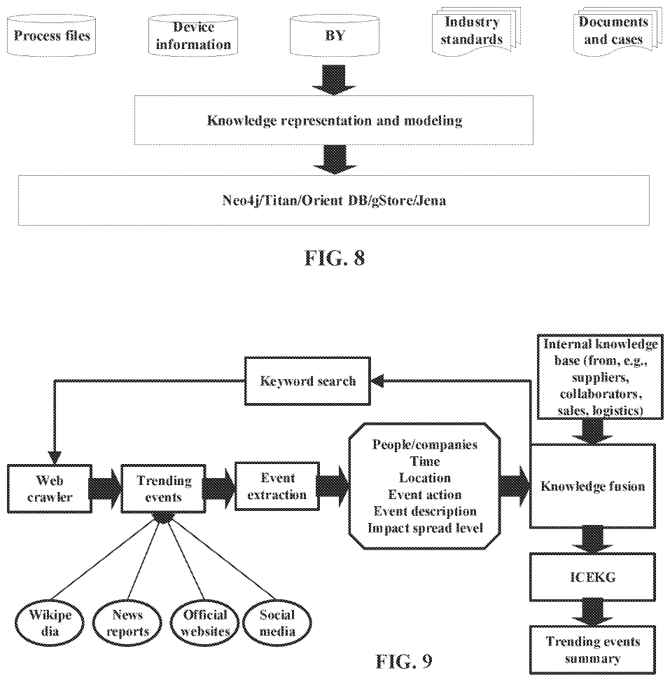

FIG. 8 illustrates a method of generating a supply chain knowledge graph in some embodiments according to the present disclosure. Referring to FIG. 8, the sources from which the entities, relationships, and attributes can be extracted includes business systems BY, industry standards, process files, documents and cases, device information. In the step of knowledge representation and modeling, the extraction tool(s) is configured to comprehend business logic; extract entities, relationships, and attributes; construct business level knowledge graph data fusions and supplements based on various applications; and extract structured data into entity tables and relationship tables (e.g., by an ETL tool). As shown in FIG. 8, in one example, the extracted entities, extracted relationships, and extracted attributes in knowledge graph database, examples of which include Neo4j, Titan, Orient DB, gStore, and Jena.

In some embodiments, to extract entities, relationships, and attributes from the unstructured data, the memory further stores computer-executable instructions for controlling the one or more processors to construct entity recognition dictionary and entity recognition rules; expand the entity recognition rules using heuristic algorithm to generate new rules, based on the entity recognition dictionary and the entity recognition rules; construct entity recognition rule base comprising the entity recognition rules and the new rules; construct the entity extraction template based on the entity recognition rule base; and construct the relationship extraction template and attribute extraction template based on keywords, lexical, and syntactic analysis.

Referring to FIG. 7, the intelligent management system ISM in some embodiments further includes an industry chain event knowledge graph generator GICEKG configured to generate the industry chain event knowledge graph ICEKG by extracting entities, relationships, and attributes from sources comprising at least one of and internal knowledge base or public web knowledge base. In some embodiments, the industry chain event knowledge graph generator GICEKG includes a memory and one or more processors. The memory and the one or more processors are connected with each other. To extract entities, relationships, and attributes from the public web knowledge base, the memory stores computer-executable instructions for controlling the one or more processors to crawl the public web knowledge base by a web crawler to obtain trending events in a relevant industry; extract entities, relationships, and attributes from the trending events respectively using entity extraction template, relationship extraction template, and attribute extraction template; perform knowledge fusion among the internal knowledge base, extracted entities, extracted relationships, and extracted attributes to generate a fused knowledge base; extract new keywords from a fused knowledge base; and reiterate crawling the public web knowledge base, extracting entities, relationships, and attributes from the trending events, and performing knowledge fusion.

As used herein, the term “crawling” as used herein relates to the process of browsing through a network of computing devices, for example the Internet®, in a methodical and/or automated manner using a link. Furthermore, crawling includes extracting data stored in one of the computing devices of the network. Moreover, crawling refers to analyzing and indexing the extracted data in a manner that enables optimizing the process of extracting data stored in the computing devices of the network. Additionally, crawling can include one or more specifications of what to crawl, including how, when, and other parameters for controlling the process of crawling. Optionally, crawling includes extracting back data related to static data or resource files that are associated with the links. Furthermore, crawling can include extracting dynamic data from the link, such as the data downloaded from the Internet or displayed by the link, upon execution.

In some embodiments, to extract entities, relationships, and attributes from the trending events, the memory further stores computer-executable instructions for controlling the one or more processors to construct entity recognition dictionary and entity recognition rules; expand the entity recognition rules using heuristic algorithm to generate new rules, based on the entity recognition dictionary and the entity recognition rules; construct entity recognition rule base comprising the entity recognition rules and the new rules; construct the entity extraction template based on the entity recognition rule base; and construct the relationship extraction template and attribute extraction template based on keywords, lexical, and syntactic analysis.

Optionally, the memory further stores computer-executable instructions for controlling the one or more processors to reiterate crawling the public web knowledge base, extracting entities, relationships, and attributes from the trending events, and performing knowledge fusion.

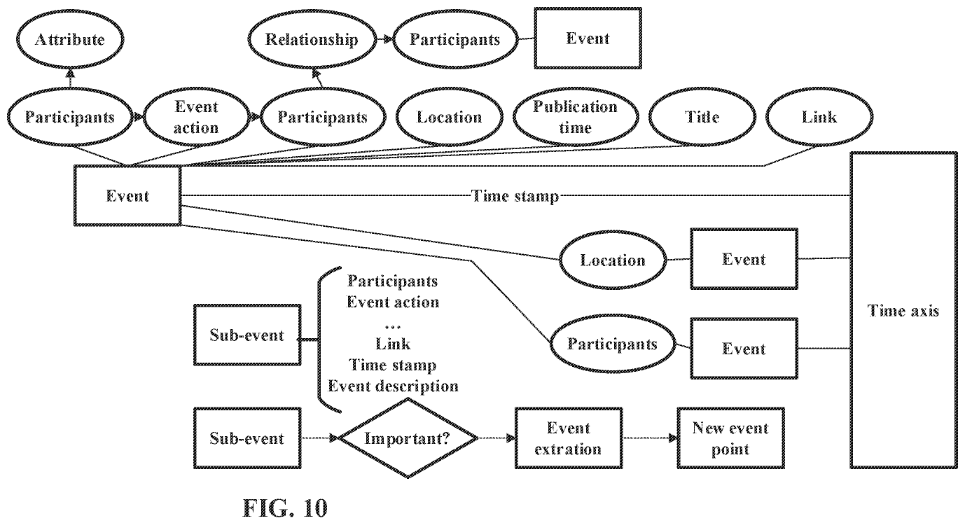

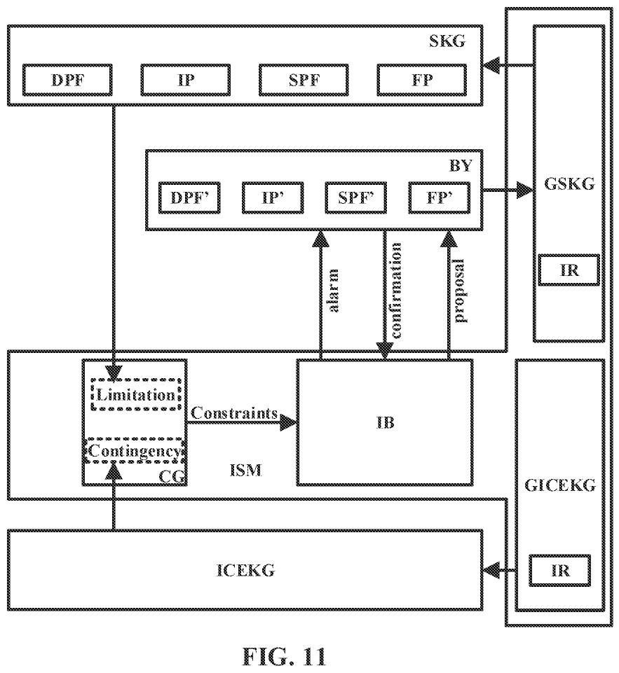

FIG. 9 illustrates a method of generating an industry chain event knowledge graph in some embodiments according to the present disclosure. Referring to FIG. 9, the trending events may be obtained from various sources including Wikipedia, news reports, official websites, and social media. In order to crawl the public web knowledge base by the web crawler, in some embodiments, the memory further stores computer-executable instructions for controlling the one or more processors to initialize a crawler task based on a seed webpage; download and parse the seed webpage to locate basic information on the seed webpage according to JSoup selector syntax; add related events, tasks, and links to entity words on the seed webpage to a crawl queue; and store parsed data in Json format to a text. Optionally, during initializing the crawler task, the web crawler is configured to set a number of threads, set a visit interval, and set a number of retrials. Referring to FIG. 9, once the crawler task begins, various information may be extracted from the trending events, including people, companies, time, location, event action, event description, and impact spread level. The extracted trending event information is fused with internal knowledge base (“knowledge fusion”). The internal knowledge base may include knowledge from supplies, collaborators, sales, and logistics. From the fused knowledge base, new keywords may be extracted. The new keywords may be provided to the web crawler, to reiterate crawling the public web knowledge base. FIG. 10 illustrates the structure of an industry chain event knowledge graph in some embodiments according to the present disclosure.

In some embodiments, referring to FIG. 9, the industry chain event knowledge graph generator GICEKG is further configured to generate trending events summary. In one example, the trending events summary is generated based on a TextRank algorithm. In some embodiments, to generate the trending events summary, the memory stores computer-executable instructions for controlling the one or more processors to treat sentences in the industry chain event knowledge graph as nodes; connect nodes in the industry chain event knowledge graph with vectorless weighted edges, wherein a respective weight of a respective edge is a similarity between respective two nodes connected by the respective edge; construct a vectorless weighted graph G (V, E, W) based on the nodes and the vectorless weighted edges, wherein V stands for the nodes, E stands for the vectorless weighted edges, and W stands for similarities respectively between connected nodes; calculate importance respectively of the nodes; rank the importance respectively of the nodes; and form the trending events summary using selected nodes having relatively high ranking.

In some embodiments, the importance are calculated according to Equation (1):

$$WS ( {S}_{i} ) = ( 1 - d ) + d * {\sum }_{{S}_{j} ∈ In ( {S}_{i} )} WS ( {S}_{j} ) * \frac{{w}_{ji}}{{\sum }_{{S}_{k} ∈ Out ( {S}_{j} )} {w}_{jk}} ; \qquad ( 1 )$$

wherein Sᵢ stands for an i-th node; WS(Sᵢ) stands for importance for the i-th node, Sⱼ stands for an j-th node; wⱼᵢ stands for similarity between the i-th node and the j-th node; d stands for a damping coefficient, indicating probability of the i-th node being selected as one of the selected nodes; ln(Sᵢ) stands for a set of nodes pointing to the i-th node; Out(Sⱼ) stands for a set of nodes pointing to the j-th node.

In some embodiments, the entity extraction template is configured to extract one or more entities selected from a group consisting of factory, logistics company, order, raw material supplier, part supplier, subcontractor, distributor, inventory, material, budget, country, region, industry chain long downstream enterprise, partner, outsourcing vendor, key equipment, financial institution, market, policy, production plan, industry standard, output, order priority level, target, single line production index, product cycle, constraint, production stoppage, abnormal weather, disease, natural disaster, personnel transfer, and time

In some embodiments, the relationship extraction template is configured to extract one or more relationships selected from a group consisting of acquisition, financing, merger, upstream, downstream, receipt, payment, pickup, delivery, demand, purchase, maintenance, from, containment, cooperation, strategic partnership, impact, conformity, distribution, priority, receipt, bottleneck, limitation, cause and effect, chronology, and regional relationships.

In some embodiments, the attribute extraction template is configured to extract one or more attributes selected from a group consisting of position, amount, order status, delivery status, enterprise status, equipment status, cooperation status, transportation status, production status, financial status, payment status.

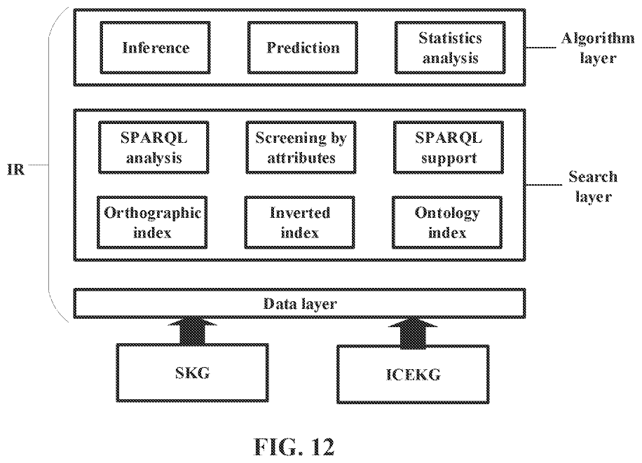

In some embodiments, at least one of the supply chain knowledge graph generator or the industry chain event knowledge graph generator includes an inferencer configured to infer at least one of a relationship between two entities or a category for an entity. FIG. 11 illustrates an intelligent management system in some embodiments according to the present disclosure. Referring to FIG. 11, both the supply chain knowledge graph generator GSKG and the industry chain event knowledge graph generator GICEKG includes an inferencer IR. FIG. 12 illustrates the structure of an inferencer in some embodiments according to the present disclosure. Referring to FIG. 12, the inferencer IR in some embodiments includes a data layer configured to receive data from the supply chain knowledge graph SKG and/or the industry chain event knowledge graph ICEKG. The inferencer IR in some embodiments further includes a search layer. In some embodiments, the search layer includes a plurality of modules including an orthographic index module, an inverted index module, an ontology index module, a SPARQL analysis module, a screening by attributes module, and a SPARQL support module. In some embodiments, the inferencer IR further includes an algorithm layer. Optionally, the algorithm layer includes a plurality of modules including an inference module, a prediction module, and a statistics analysis module.

In some embodiments, the inferencer IR is configured to infer at least one of a relationship between two entities or a category for an entity. In some embodiments, the inferencer IR includes a memory; one or more processors. The memory and the one or more processors are connected with each other. The memory stores computer-executable instructions for controlling the one or more processors to infer the category for the entity based on constraints in ontological framework of a knowledge graph, the constraints comprising definition domain and value domain of a relationship connected to the entity.

In some embodiments, the memory stores computer-executable instructions for controlling the one or more processors to make an inference using a scoring algorithm. Optionally, the scoring algorithm includes similarity between entity 1 and (relationship Ô entity 2); similarity between (entity 1 Ô relationship) and entity 2; and similarity between relationship and (entity 1 Ô entity 2); wherein Ô stands for a linear or non-linear operation selected from a group consisting of addition, multiplication, and a neural network operation.

Optionally, the memory further stores computer-executable instructions for controlling the one or more processors to train parameters of the scoring algorithm using a training data set.

In another aspect, the present disclosure provides an intelligent management method. In some embodiments, the intelligent management method includes generating supply chain limitations based on a supply chain knowledge graph comprising information of at least one of demand planning and forecasting, inventory planning, sales planning and forecasting, or budget planning; generating industry chain contingencies based on an industry chain event knowledge graph comprising information of at least one of event urgency level, event importance level, and event impact spread level; generating constraints on supply chain based on supply chain limitations and industry chain contingencies; and generating a proposal and providing the proposal to business systems for supply chain planning based on the constraints on supply chain, the proposal comprising proposal for at least one of demand re-planning and re-forecasting, inventory re-planning, sales re-planning and re-forecasting, or budget re-planning.

In some embodiments, the intelligent management method further includes generating an alarm and providing the alarm to the business systems based on a potential conflict between the supply chain limitations and industry chain contingencies; and receiving a confirmation from the business systems confirming the potential conflict. Optionally, the proposal is generated upon receiving the confirmation. Optionally, the proposal includes a set of alternative proposals respectively based on alternative priorities.

In some embodiments, the intelligent management method further includes generating, by a supply chain knowledge graph generator, the supply chain knowledge graph by extracting entities, relationships, and attributes from sources comprising at least one of the business systems or industry standards. Specifically, the intelligent management method includes extracting entities and relationships from structured data using an extraction tool; extracting entities, relationships, and attributes from unstructured data respectively using entity extraction template, relationship extraction template, and attribute extraction template; and storing extracted entities, extracted relationships, and extracted attributes in knowledge graph database, upon expert validation.

In some embodiments, extracting entities, relationships, and attributes from the unstructured data includes constructing entity recognition dictionary and entity recognition rules; expanding the entity recognition rules using heuristic algorithm to generate new rules, based on the entity recognition dictionary and the entity recognition rules; constructing entity recognition rule base comprising the entity recognition rules and the new rules; constructing the entity extraction template based on the entity recognition rule base; and constructing the relationship extraction template and attribute extraction template based on keywords, lexical, and syntactic analysis.

In some embodiments, the intelligent management method further includes generating, by an industry chain event knowledge graph generator, the industry chain event knowledge graph by extracting entities, relationships, and attributes from sources comprising at least one of and internal knowledge base or public web knowledge base. Specifically, the intelligent management method includes crawling the public web knowledge base by a web crawler to obtain trending events in a relevant industry; extracting entities, relationships, and attributes from the trending events respectively using entity extraction template, relationship extraction template, and attribute extraction template; performing knowledge fusion among the internal knowledge base, extracted entities, extracted relationships, and extracted attributes to generate a fused knowledge base; extracting new keywords from a fused knowledge base; and reiterating crawling the public web knowledge base, extracting entities, relationships, and attributes from the trending events, and performing knowledge fusion.

In some embodiments, extracting entities, relationships, and attributes from the trending events includes constructing entity recognition dictionary and entity recognition rules; expanding the entity recognition rules using heuristic algorithm to generate new rules, based on the entity recognition dictionary and the entity recognition rules; constructing entity recognition rule base comprising the entity recognition rules and the new rules; constructing the entity extraction template based on the entity recognition rule base; and constructing the relationship extraction template and attribute extraction template based on keywords, lexical, and syntactic analysis.

In some embodiments, the intelligent management method further includes reiterating crawling the public web knowledge base, extracting entities, relationships, and attributes from the trending events, and performing knowledge fusion.

In some embodiments, the intelligent management method further includes generating trending events summary based on a TextRank algorithm. Specifically, generating trending events summary includes treating sentences in the industry chain event knowledge graph as nodes; connecting nodes in the industry chain event knowledge graph with vectorless weighted edges, wherein a respective weight of a respective edge is a similarity between respective two nodes connected by the respective edge; constructing a vectorless weighted graph G (V, E, W) based on the nodes and the vectorless weighted edges, wherein V stands for the nodes, E stands for the vectorless weighted edges, and W stands for similarities respectively between connected nodes; calculating importance respectively of the nodes; ranking the importance respectively of the nodes; and forming the trending events summary using selected nodes having relatively high ranking.

In some embodiments, the importance are calculated according to Equation (1):

$$WS ( {S}_{i} ) = ( 1 - d ) + d * {\sum }_{{S}_{j} ∈ In ( {S}_{i} )} WS ( {S}_{j} ) * \frac{{w}_{ji}}{{\sum }_{{S}_{k} ∈ Out ( {S}_{j} )} {w}_{jk}} ; \qquad ( 1 )$$

wherein Sᵢ stands for an i-th node; WS(Sᵢ) stands for importance for the i-th node; Sⱼ stands for an j-th node; wⱼᵢ stands for similarity between the i-th node and the j-th node; d stands for a damping coefficient, indicating probability of the i-th node being selected as one of the selected nodes; ln(Sᵢ) stands for a set of nodes pointing to the i-th node; Out(Sⱼ) stands for a set of nodes pointing to the j-th node.

In some embodiments, crawling the public web knowledge base by the web crawler includes initializing a crawler task based on a seed webpage; downloading and parsing the seed webpage to locate basic information on the seed webpage according to JSoup selector syntax; adding related events, tasks, and links to entity words on the seed webpage to a crawl queue; and storing parsed data in Json format to a text.

In some embodiments, the entity extraction template is configured to extract one or more entities selected from a group consisting of factory, logistics company, order, raw material supplier, part supplier, subcontractor, distributor, inventory, material, budget, country, region, industry chain long downstream enterprise, partner, outsourcing vendor, key equipment, financial institution, market, policy, production plan, industry standard, output, order priority level, target, single line production index, product cycle, constraint, production stoppage, abnormal weather, disease, natural disaster, personnel transfer, and time.

In some embodiments, the relationship extraction template is configured to extract one or more relationships selected from a group consisting of acquisition, financing, merger, upstream, downstream, receipt, payment, pickup, delivery, demand, purchase, maintenance, from, containment, cooperation, strategic partnership, impact, conformity, distribution, priority, receipt, bottleneck, limitation, cause and effect, chronology, and regional relationships.

In some embodiments, the attribute extraction template is configured to extract one or more attributes selected from a group consisting of position, amount, order status, delivery status, enterprise status, equipment status, cooperation status, transportation status, production status, financial status, payment status.

In some embodiments, the intelligent management method further includes inferring at least one of a relationship between two entities or a category for an entity. Optionally, inferring the category for the entity is based on constraints in ontological framework of a knowledge graph, the constraints including definition domain and value domain of a relationship connected to the entity.

In some embodiments, the intelligent management method further includes making an inference using a scoring algorithm. Optionally, the scoring algorithm includes similarity between entity 1 and (relationship Ô entity 2); similarity between (entity 1 Ô relationship) and entity 2; and similarity between relationship and (entity 1 Ô entity 2); wherein Ô stands for a linear or non-linear operation selected from a group consisting of addition, multiplication, and a neural network operation.

In some embodiments, the intelligent management method further includes training parameters of the scoring algorithm using a training data set.

In another aspect, the present disclosure provides a computer-program product. The computer-program product includes a non-transitory tangible computer-readable medium having computer-readable instructions thereon. In some embodiments, the computer-readable instructions are executable by a processor to cause the processor to perform generating supply chain limitations based on a supply chain knowledge graph comprising information of at least one of demand planning and forecasting, inventory planning, sales planning and forecasting, or budget planning; generating industry chain contingencies based on an industry chain event knowledge graph comprising information of at least one of event urgency level, event importance level, and event impact spread level; generating constraints on supply chain based on supply chain limitations and industry chain contingencies; and generating a proposal and providing the proposal to business systems for supply chain planning based on the constraints on supply chain, the proposal comprising proposal for at least one of demand re-planning and re-forecasting, inventory re-planning, sales re-planning and re-forecasting, or budget re-planning.

In some embodiments, the computer-readable instructions are executable by a processor to cause the processor to further perform generating an alarm and providing the alarm to the business systems based on a potential conflict between the supply chain limitations and industry chain contingencies; and receiving a confirmation from the business systems confirming the potential conflict. Optionally, the proposal is generated upon receiving the confirmation. Optionally, the proposal includes a set of alternative proposals respectively based on alternative priorities.

In some embodiments, the computer-readable instructions are executable by a processor to cause the processor to further perform generating, by a supply chain knowledge graph generator, the supply chain knowledge graph by extracting entities, relationships, and attributes from sources comprising at least one of the business systems or industry standards. Specifically, the computer-readable instructions are executable by a processor to cause the processor to further perform extracting entities and relationships from structured data using an extraction tool; extracting entities, relationships, and attributes from unstructured data respectively using entity extraction template, relationship extraction template, and attribute extraction template; and storing extracted entities, extracted relationships, and extracted attributes in knowledge graph database, upon expert validation.

In some embodiments, to extract entities, relationships, and attributes from the unstructured data, the computer-readable instructions are executable by a processor to cause the processor to further perform constructing entity recognition dictionary and entity recognition rules; expanding the entity recognition rules using heuristic algorithm to generate new rules, based on the entity recognition dictionary and the entity recognition rules; constructing entity recognition rule base comprising the entity recognition rules and the new rules; constructing the entity extraction template based on the entity recognition rule base; and constructing the relationship extraction template and attribute extraction template based on keywords, lexical, and syntactic analysis.

In some embodiments, the computer-readable instructions are executable by a processor to cause the processor to further perform generating, by an industry chain event knowledge graph generator, the industry chain event knowledge graph by extracting entities, relationships, and attributes from sources comprising at least one of and internal knowledge base or public web knowledge base. Specifically, the computer-readable instructions are executable by a processor to cause the processor to further perform crawling the public web knowledge base by a web crawler to obtain trending events in a relevant industry; extracting entities, relationships, and attributes from the trending events respectively using entity extraction template, relationship extraction template, and attribute extraction template; performing knowledge fusion among the internal knowledge base, extracted entities, extracted relationships, and extracted attributes to generate a fused knowledge base; extracting new keywords from a fused knowledge base; and reiterating crawling the public web knowledge base, extracting entities, relationships, and attributes from the trending events, and performing knowledge fusion.

In some embodiments, to extract entities, relationships, and attributes from the trending events, the computer-readable instructions are executable by a processor to cause the processor to further perform constructing entity recognition dictionary and entity recognition rules; expanding the entity recognition rules using heuristic algorithm to generate new rules, based on the entity recognition dictionary and the entity recognition rules; constructing entity recognition rule base comprising the entity recognition rules and the new rules; constructing the entity extraction template based on the entity recognition rule base; and constructing the relationship extraction template and attribute extraction template based on keywords, lexical, and syntactic analysis.

In some embodiments, the computer-readable instructions are executable by a processor to cause the processor to further perform reiterating crawling the public web knowledge base, extracting entities, relationships, and attributes from the trending events, and performing knowledge fusion.

In some embodiments, the computer-readable instructions are executable by a processor to cause the processor to further perform generating trending events summary based on a TextRank algorithm. Specifically, generating trending events summary includes treating sentences in the industry chain event knowledge graph as nodes; connecting nodes in the industry chain event knowledge graph with vectorless weighted edges, wherein a respective weight of a respective edge is a similarity between respective two nodes connected by the respective edge; constructing a vectorless weighted graph G (V, E, W) based on the nodes and the vectorless weighted edges, wherein V stands for the nodes, E stands for the vectorless weighted edges, and W stands for similarities respectively between connected nodes; calculating importance respectively of the nodes; ranking the importance respectively of the nodes; and forming the trending events summary using selected nodes having relatively high ranking.

In some embodiments, the importance are calculated according to Equation (1):

$$WS ( {S}_{i} ) = ( 1 - d ) + d * {\sum }_{{S}_{j} ∈ In ( {S}_{i} )} WS ( {S}_{j} ) * \frac{{w}_{ji}}{{\sum }_{{S}_{k} ∈ Out ( {S}_{j} )} {w}_{jk}} ; \qquad ( 1 )$$

wherein Sᵢ stands for an i-th node; WS(Sᵢ) stands for importance for the i-th node; Sⱼ stands for an j-th node; wⱼᵢ stands for similarity between the i-th node and the j-th node; d stands for a damping coefficient, indicating probability of the i-th node being selected as one of the selected nodes; ln(Sᵢ) stands for a set of nodes pointing to the i-th node; Out(Sⱼ) stands for a set of nodes pointing to the j-th node.

In some embodiments, to crawl the public web knowledge base by the web crawler, the computer-readable instructions are executable by a processor to cause the processor to further perform initializing a crawler task based on a seed webpage; downloading and parsing the seed webpage to locate basic information on the seed webpage according to JSoup selector syntax; adding related events, tasks, and links to entity words on the seed webpage to a crawl queue; and storing parsed data in Json format to a text.

In some embodiments, the entity extraction template is configured to extract one or more entities selected from a group consisting of factory, logistics company, order, raw material supplier, part supplier, subcontractor, distributor, inventory, material, budget, country, region, industry chain long downstream enterprise, partner, outsourcing vendor, key equipment, financial institution, market, policy, production plan, industry standard, output, order priority level, target, single line production index, product cycle, constraint, production stoppage, abnormal weather, disease, natural disaster, personnel transfer, and time.

In some embodiments, the relationship extraction template is configured to extract one or more relationships selected from a group consisting of acquisition, financing, merger, upstream, downstream, receipt, payment, pickup, delivery, demand, purchase, maintenance, from, containment, cooperation, strategic partnership, impact, conformity, distribution, priority, receipt, bottleneck, limitation, cause and effect, chronology, and regional relationships.

In some embodiments, the attribute extraction template is configured to extract one or more attributes selected from a group consisting of position, amount, order status, delivery status, enterprise status, equipment status, cooperation status, transportation status, production status, financial status, payment status.

In some embodiments, the computer-readable instructions are executable by a processor to cause the processor to further perform inferring at least one of a relationship between two entities or a category for an entity. Optionally, the computer-readable instructions are executable by a processor to cause the processor to further perform inferring the category for the entity based on constraints in ontological framework of a knowledge graph, the constraints including definition domain and value domain of a relationship connected to the entity.

In some embodiments, the computer-readable instructions are executable by a processor to cause the processor to further perform making an inference using a scoring algorithm. Optionally, the scoring algorithm includes similarity between entity 1 and (relationship Ô entity 2); similarity between (entity 1 Ô relationship) and entity 2; and similarity between relationship and (entity 1 Ô entity 2); wherein Ô stands for a linear or non-linear operation selected from a group consisting of addition, multiplication, and a neural network operation.

In some embodiments, the computer-readable instructions are executable by a processor to cause the processor to further perform training parameters of the scoring algorithm using a training data set.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. An intelligent management system, comprising:
a supply chain knowledge graph;
an industry chain event knowledge graph; and
an intelligent supply chain manager connected to the supply chain knowledge graph and the industry chain event knowledge graph;
wherein the intelligent supply chain manager comprises:
a memory;
one or more processors;
wherein the memory and the one or more processors are connected with each other; and
the memory stores computer-executable instructions for controlling the one or more processors to:
generate supply chain limitations based on the supply chain knowledge graph comprising information of at least one of demand planning and forecasting, inventory planning, sales planning and forecasting, or budget planning;
generate industry chain contingencies based on the industry chain event knowledge graph comprising information of at least one of event urgency level, event importance level, and event impact spread level;
generate constraints on supply chain based on supply chain limitations and industry chain contingencies; and
generate a proposal and provide the proposal to business systems for supply chain planning based on the constraints on supply chain, the proposal comprising proposal for at least one of demand re-planning and re-forecasting, inventory re-planning, sales re-planning and re-forecasting, or budget re-planning.

2. The intelligent management system of claim 1, wherein the memory further stores computer-executable instructions for controlling the one or more processors to:
generate an alarm and provide the alarm to the business systems based on a potential conflict between the supply chain limitations and industry chain contingencies; and
receive a confirmation from the business systems confirming the potential conflict;
wherein the proposal is generated upon receiving the confirmation.

3. The intelligent management system of claim 1, wherein the proposal comprises a set of alternative proposals respectively based on alternative priorities.

4. The intelligent management system of claim 1, further comprising a supply chain knowledge graph generator configured to generate the supply chain knowledge graph by extracting entities, relationships, and attributes from sources comprising at least one of the business systems or industry standards;
wherein the supply chain knowledge graph generator comprises:
a memory;
one or more processors;
wherein the memory and the one or more processors are connected with each other; and
the memory stores computer-executable instructions for controlling the one or more processors to:
extract entities and relationships from structured data using an extraction tool;
extract entities, relationships, and attributes from unstructured data respectively using entity extraction template, relationship extraction template, and attribute extraction template; and
store extracted entities, extracted relationships, and extracted attributes in knowledge graph database, upon expert validation.

5. The intelligent management system of claim 4, wherein, to extract entities, relationships, and attributes from the unstructured data, the memory further stores computer-executable instructions for controlling the one or more processors to:
construct entity recognition dictionary and entity recognition rules;
expand the entity recognition rules using heuristic algorithm to generate new rules, based on the entity recognition dictionary and the entity recognition rules;
construct entity recognition rule base comprising the entity recognition rules and the new rules;
construct the entity extraction template based on the entity recognition rule base; and
construct the relationship extraction template and attribute extraction template based on keywords, lexical, and syntactic analysis.

6. The intelligent management system of claim 1, further comprising an industry chain event knowledge graph generator configured to generate the industry chain event knowledge graph by extracting entities, relationships, and attributes from sources comprising at least one of and internal knowledge base or public web knowledge base;
wherein the industry chain event knowledge graph generator comprises:
a memory;
one or more processors;
wherein the memory and the one or more processors are connected with each other; and
the memory stores computer-executable instructions for controlling the one or more processors to:
crawl the public web knowledge base by a web crawler to obtain trending events in a relevant industry;
extract entities, relationships, and attributes from the trending events respectively using entity extraction template, relationship extraction template, and attribute extraction template;
perform knowledge fusion among the internal knowledge base, extracted entities, extracted relationships, and extracted attributes to generate a fused knowledge base;
extract new keywords from a fused knowledge base; and
reiterate crawling the public web knowledge base, extracting entities, relationships, and attributes from the trending events, and performing knowledge fusion.

7. The intelligent management system of claim 6, wherein, to extract entities, relationships, and attributes from the trending events, the memory further stores computer-executable instructions for controlling the one or more processors to:
construct entity recognition dictionary and entity recognition rules;
expand the entity recognition rules using heuristic algorithm to generate new rules, based on the entity recognition dictionary and the entity recognition rules;
construct entity recognition rule base comprising the entity recognition rules and the new rules;
construct the entity extraction template based on the entity recognition rule base; and
construct the relationship extraction template and attribute extraction template based on keywords, lexical, and syntactic analysis.

8. The intelligent management system of claim 6, wherein the memory further stores computer-executable instructions for controlling the one or more processors to reiterate crawling the public web knowledge base, extracting entities, relationships, and attributes from the trending events, and performing knowledge fusion.

9. The intelligent management system of claim 6, wherein the memory further stores computer-executable instructions for controlling the one or more processors to generate trending events summary based on a TextRank algorithm;
wherein, to generate the trending events summary, the memory stores computer-executable instructions for controlling the one or more processors to:
treat sentences in the industry chain event knowledge graph as nodes;
connect nodes in the industry chain event knowledge graph with vectorless weighted edges, wherein a respective weight of a respective edge is a similarity between respective two nodes connected by the respective edge;
construct a vectorless weighted graph G (V, E, W) based on the nodes and the vectorless weighted edges, wherein V stands for the nodes, E stands for the vectorless weighted edges, and W stands for similarities respectively between connected nodes;
calculate importance respectively of the nodes;
rank the importance respectively of the nodes; and
form the trending events summary using selected nodes having relatively high ranking.

10. The intelligent management system of claim 9, wherein the importance are calculated according to Equation (1):
$$WS ( {S}_{i} ) = ( 1 - d ) + d * {\sum }_{{S}_{j} ∈ In ( {S}_{i} )} WS ( {S}_{j} ) * \frac{{w}_{ji}}{{\sum }_{{S}_{k} ∈ Out ( {S}_{j} )} {w}_{jk}} ; \qquad ( 1 )$$
wherein Sᵢ stands for an i-th node; WS(Sᵢ) stands for importance for the i-th node; Sⱼ stands for an j-th node; wⱼᵢ stands for similarity between the i-th node and the j-th node; d stands for a damping coefficient, indicating probability of the i-th node being selected as one of the selected nodes; ln(Sᵢ) stands for a set of nodes pointing to the i-th node; Out(Sⱼ) stands for a set of nodes pointing to the j-th node.

11. The intelligent management system of claim 6, wherein, to crawl the public web knowledge base by the web crawler, the memory further stores computer-executable instructions for controlling the one or more processors to:
initialize a crawler task based on a seed webpage;
download and parse the seed webpage to locate basic information on the seed webpage according to JSoup selector syntax;
add related events, tasks, and links to entity words on the seed webpage to a crawl queue; and
store parsed data in Json format to a text.

12. The intelligent management system of claim 6, wherein the entity extraction template is configured to extract one or more entities selected from a group consisting of factory, logistics company, order, raw material supplier, part supplier, subcontractor, distributor, inventory, material, budget, country, region, industry chain long downstream enterprise, partner, outsourcing vendor, key equipment, financial institution, market, policy, production plan, industry standard, output, order priority level, target, single line production index, product cycle, constraint, production stoppage, abnormal weather, disease, natural disaster, personnel transfer, and time.

13. The intelligent management system of claim 6, wherein the relationship extraction template is configured to extract one or more relationships selected from a group consisting of acquisition, financing, merger, upstream, downstream, receipt, payment, pickup, delivery, demand, purchase, maintenance, from, containment, cooperation, strategic partnership, impact, conformity, distribution, priority, receipt, bottleneck, limitation, cause and effect, chronology, and regional relationships.

14. The intelligent management system of claim 6, wherein the attribute extraction template is configured to extract one or more attributes selected from a group consisting of position, amount, order status, delivery status, enterprise status, equipment status, cooperation status, transportation status, production status, financial status, payment status.

15. The intelligent management system of claim 1, further comprising a supply chain knowledge graph generator configured to generate the supply chain knowledge graph and an industry chain event knowledge graph generator configured to generate the industry chain event knowledge graph;
wherein at least one of the supply chain knowledge graph generator or the industry chain event knowledge graph generator comprises an inferencer configured to infer at least one of a relationship between two entities or a category for an entity.

16. The intelligent management system of claim 15, wherein the inferencer comprises:
a memory;
one or more processors;
wherein the memory and the one or more processors are connected with each other; and
the memory stores computer-executable instructions for controlling the one or more processors to infer the category for the entity based on constraints in ontological framework of a knowledge graph, the constraints comprising definition domain and value domain of a relationship connected to the entity.

17. The intelligent management system of claim 15, wherein the inferencer comprises:
a memory;
one or more processors;
wherein the memory and the one or more processors are connected with each other; and
the memory stores computer-executable instructions for controlling the one or more processors to make an inference using a scoring algorithm;
wherein the scoring algorithm comprises:
similarity between entity 1 and (relationship Ô entity 2);
similarity between (entity 1 Ô relationship) and entity 2; and
similarity between relationship and (entity 1 Ô entity 2);
wherein Ô stands for a linear or non-linear operation selected from a group consisting of addition, multiplication, and a neural network operation.

18. The intelligent management system of claim 17, wherein the memory further stores computer-executable instructions for controlling the one or more processors to train parameters of the scoring algorithm using a training data set.

19. An intelligent management method, comprising:
generating supply chain limitations based on a supply chain knowledge graph comprising information of at least one of demand planning and forecasting, inventory planning, sales planning and forecasting, or budget planning;
generating industry chain contingencies based on an industry chain event knowledge graph comprising information of at least one of event urgency level, event importance level, and event impact spread level;
generating constraints on supply chain based on supply chain limitations and industry chain contingencies; and
generating a proposal and providing the proposal to business systems for supply chain planning based on the constraints on supply chain, the proposal comprising proposal for at least one of demand re-planning and re-forecasting, inventory re-planning, sales re-planning and re-forecasting, or budget re-planning.

20. A computer-program product, comprising a non-transitory tangible computer-readable medium having computer-readable instructions thereon, the computer-readable instructions being executable by a processor to cause the processor to perform:
generating supply chain limitations based on a supply chain knowledge graph comprising information of at least one of demand planning and forecasting, inventory planning, sales planning and forecasting, or budget planning;
generating industry chain contingencies based on an industry chain event knowledge graph comprising information of at least one of event urgency level, event importance level, and event impact spread level;
generating constraints on supply chain based on supply chain limitations and industry chain contingencies; and
generating a proposal and providing the proposal to business systems for supply chain planning based on the constraints on supply chain, the proposal comprising proposal for at least one of demand re-planning and re-forecasting, inventory re-planning, sales re-planning and re-forecasting, or budget re-planning.
